(19) United States
(12) Patent Application Publication
(10) Pub. No.: US 2019/0212003 A1
(43) Pub. Date: Jul. 11, 2019

(54) LIGHTING APPARATUS

(71) Applicant: Jasco Products Company LLC, Oklahoma City, OK (US)

(72) Inventors: Trey Lazear, Oklahoma City, OK (US); Mark Solomon, Oklahoma City, OK (US)

(21) Appl. No.: 16/242,634

(22) Filed: Jan. 8, 2019

Related U.S. Application Data
(60) Provisional application No. 62/614,732, filed on Jan. 8, 2018.

(51) Int. Cl. F21V 23/04; F21V 21/02; F21V 21/30; F21V 3/00; H05B 37/02

(52) U.S. Cl. CPC F21V 23/0471; F21V 21/02; F21V 23/0435; F21V 3/00; H05B 37/0281; F21V 21/30

(57) ABSTRACT

Disclosed is a lighting apparatus. The lighting apparatus may include a voltage regulator configured to provide supply of electricity to the lighting apparatus. Further, the illumination means may be configured to generate light emission. Further, the lighting apparatus may include one or more motion sensors configured for detecting a motion in a vicinity of the lighting apparatus. Further, the lighting apparatus may include an ancillary sensor configured to detect a characteristic of environmental light. Further, the lighting apparatus may include switches configured to control operation of the illumination means. Further, the lighting apparatus may include a processor electrically coupled to each of the illumination means, the one or more motion sensors, the ancillary sensor and the switches. Further, the processor may be configured to control operation of the illumination means based on the motion, the characteristic of environmental light and outputs of the switches.

The current application claims a priority to the U.S. Provisional Patent application Ser. No. 62/614,732 filed on Jan. 8, 2018.

### FIELD OF THE INVENTION

The present invention relates generally to a lighting apparatus. More particularly, the present invention relates to a light apparatus for providing accent lighting and security lighting.

### BACKGROUND OF THE INVENTION

Presently, there are articles of security lighting, and there are articles of accent lighting, however, there is a lack of articles and apparatuses that merge these two features together through a plurality of switches and the protocol thereof. Further, the means of sensory for such a system are often ingrained to the system and do not provide relief or control of the system thereof outside of a single authorizing and shut off switch.

Accordingly, there is a need for improved lighting apparatus that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a lighting apparatus may include a voltage regulator configured to provide supply of electricity to the lighting apparatus. Further, the lighting apparatus may include a plurality of illumination means electrically coupled to the voltage regulator. Further, the plurality of illumination means may be configured to generate light emission. Further, the lighting apparatus may include one or more motion sensors configured for detecting a motion in a vicinity of the lighting apparatus. Further, the lighting apparatus may include an ancillary sensor configured to detect a characteristic of environmental light. Further, the lighting apparatus may include a plurality of switches configured to control operation of the plurality of illumination means. Further, the lighting apparatus may include a processor electrically coupled to each of the plurality of illumination means, the one or more motion sensors, the ancillary sensor and the plurality of switches. Further, the processor may be configured to control operation of the plurality of illumination means based on the motion, the characteristic of environmental light and a plurality of outputs of the plurality of switches.

According to some embodiments, a lighting apparatus is disclosed. The lighting apparatus may include a wall-eave mount configured to be affixed to a surface (or electrical junction box), a plurality of light housings, and a pivot joint configured to couple the plurality of light housings to the wall-eave mount. Further, the pivot joint may be configured to permit pivotal motion of the plurality of light housings in relation to the wall-eave mount. Further, the lighting apparatus may include a voltage regulator configured to provide supply of electricity to the lighting apparatus. Further, the lighting apparatus may include a plurality of illumination means electrically coupled to the voltage regulator. Further, the plurality of illumination means may be configured to generate light emission. Further, the plurality of light housings may be configured to house the plurality of illumination means. Further, the lighting apparatus may include one or more motion sensors configured for detecting a motion in a vicinity of the lighting apparatus. Further, the lighting apparatus may include an ancillary sensor configured to detect a characteristic of environmental light. Further, the lighting apparatus may include a plurality of switches configured to control operation of the plurality of illumination means. Further, the lighting apparatus may include a processor electrically coupled to each of the plurality of illumination means, the one or more motion sensors, the ancillary sensor and the plurality of switches. Further, the processor may be configured to control operation of the plurality of illumination means based on the motion, the characteristic of environmental light and a plurality of outputs of the plurality of switches. Further, the plurality of illumination means may be configured to operate in one or more of an accent light mode and a security light mode. Further, an illumination means of the plurality of illumination means, operating in the accent light mode, may be configured to generate light emission based on the characteristic of environmental light. Further, the plurality of illumination means, operating in the security light mode, may be configured to generate light emission at maximum intensity based on the characteristic of environmental light and detection of motion by the one or more motion sensors.

According to some embodiments, a method of operating a lighting apparatus is disclosed. The method may include receiving, using an ancillary sensor, detection of a characteristic of environmental light. Further, the method may include receiving, using one or more motion sensors, detection of a motion in a vicinity of the lighting apparatus. Further, the method may include generating, using a plurality of illumination means, light emission. Further, the method may include controlling, using a processor, operation of the plurality of illumination means based on the motion, the characteristic of environmental light and a plurality of outputs of a plurality of switches, wherein the plurality of illumination means is configured to operate in at least one of an accent light mode and a security light mode, wherein an illumination means of the plurality of illumination means, operating in the accent light mode, is configured to generate light emission based on the characteristic of environmental light, wherein the plurality of illumination means, operating in the security light mode, is configured to generate light emission at maximum intensity based on the characteristic of environmental light and detection of motion by the one or more motion sensors.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a lighting apparatus, in accordance with some embodiments.

FIG. 3 is a perspective view of a lighting apparatus, in accordance with some embodiments.

FIG. 4 is a front view of the lighting apparatus of FIG. 3.

FIG. 5 is a rear view of the lighting apparatus of FIG. 3.

FIG. 6 is a right side view of the lighting apparatus of FIG. 3.

FIG. 7 is a left side view of the lighting apparatus of FIG. 3.

FIG. 8 is a top view of the lighting apparatus of FIG. 3.

FIG. 9 is a bottom view of the lighting apparatus of FIG. 3.

FIG. 10 illustrates a plurality of switches of the lighting apparatus of FIG. 3.

FIG. 11 is a flowchart of a method for operating a lighting apparatus in accordance with some embodiments.

FIG. 12 is timing diagram illustrating operation of a lighting apparatus, in accordance with an exemplary embodiment.

FIG. 13 is timing diagram illustrating operation of a lighting apparatus, in accordance with an exemplary embodiment.

FIG. 14 is timing diagram illustrating operation of a lighting apparatus, in accordance with an exemplary embodiment.

FIG. 15 is timing diagram illustrating operation of a lighting apparatus, in accordance with an exemplary embodiment.

FIG. 16 is timing diagram illustrating operation of a lighting apparatus, in accordance with an exemplary embodiment.

FIG. 17 is timing diagram illustrating operation of a lighting apparatus, in accordance with an exemplary embodiment.

FIG. 18 is timing diagram illustrating operation of a lighting apparatus, in accordance with an exemplary embodiment.

FIG. 19 is a flowchart of a method for operating a lighting apparatus, in accordance with some embodiments.

FIG. 20 is a continuation of the flowchart started in FIG. 19.

FIG. 21 is a continuation of the flowchart started in FIG. 19.

FIG. 22 is a continuation of the flowchart started in FIG. 19.

FIG. 23 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of lighting devices, embodiments of the present disclosure are not limited to use only in this context.

### Overview

The present disclosure relates to a lighting apparatus capable of swapping between accent lighting and security lighting through a plurality of switches and sensory means, particularly in a nocturnal cycle.

Further, the disclosed lighting apparatus may possess both security lighting intensity features and sensory means, coupled with protocol that makes the lighting accent lighting oriented otherwise upon fulfilling the conditions of the security lighting protocol. By providing a plurality of switches with a processor to interpret the commands, the user may alter the range or sensitivity of one or more motion sensors and alter the aspects of the accent lighting to the user's discretion alongside the timespan of use of the apparatus as an accent light and the timespan of the security lighting feature. Further, the user may set the accent lighting in the initial state for a selected time frame such as 3 hr, 6 hr, or Dusk-to-Dawn, where an ancillary sensor would detect the intensity of environmental light, and thereafter set an arbitrary time of operation for the security light if the recognition of the one or more motion sensors is activated and motion is detected after the accent lighting time has expired. Thereafter, the security light may provide the strongest illumination of light upon detecting motion until the time span set prior is satisfied and will turn off until another instance of motion is detected by the one or more motion sensors. Further, an optional relay may communicate with a user's personal computing device or remote control through an interface thereof that would offer the same range of options as the plurality of switches to provide easier access to the control scheme of the apparatus. Thus, the present disclosure provides a merged security and accent lighting apparatus that further may permit variation and control of the parameters surrounding the functions of either lighting protocol with the additional consideration of at-range control over the apparatus.

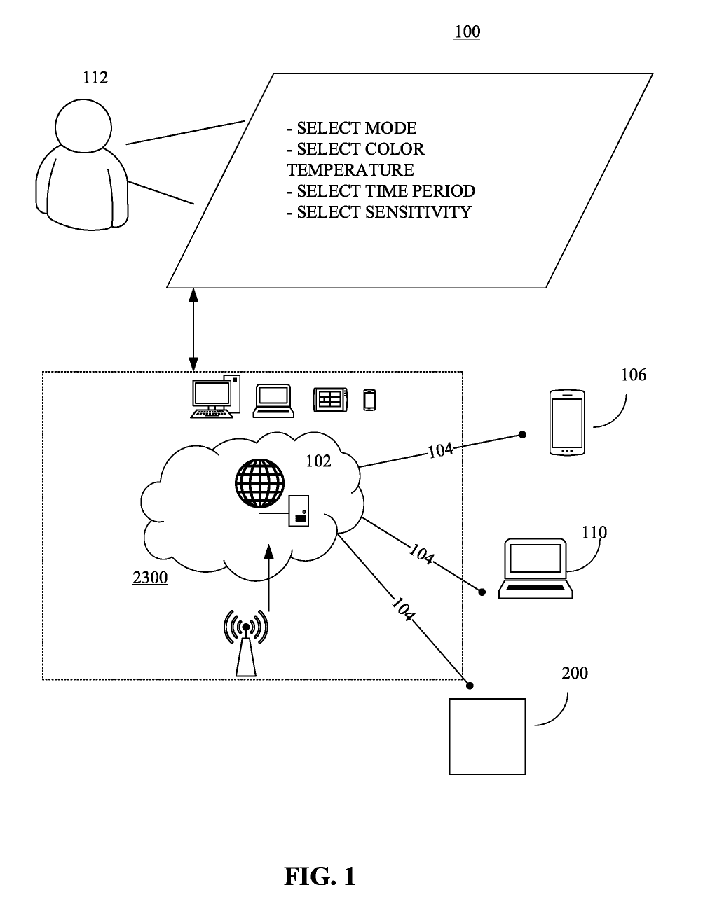

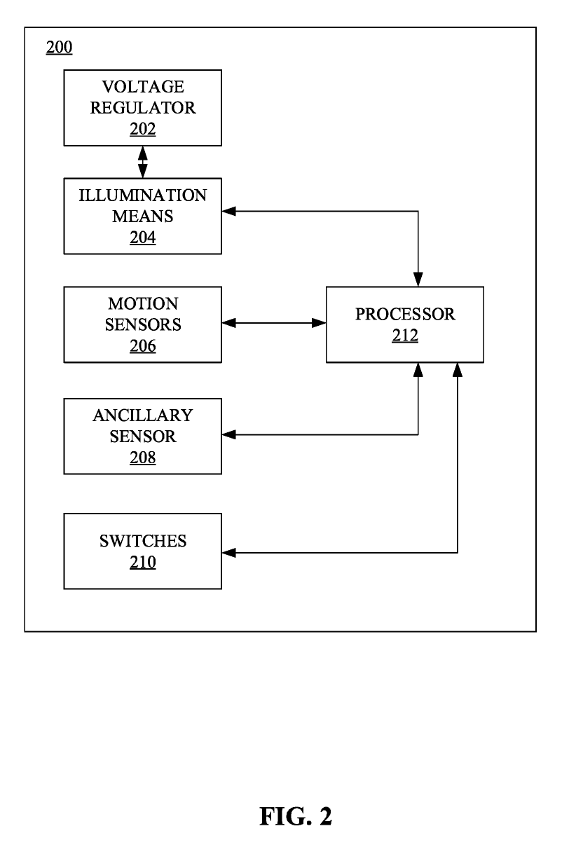

Referring now to figures, FIG. 1 is an illustration of an online platform 100 consistent with various embodiments of the present disclosure. By way of non-limiting example, the online platform 100 to facilitate operation of a lighting apparatus (such as a light apparatus 200 shown in FIG. 2 below) may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), the light apparatus 200, over a communication network 104, such as, but not limited to, the Internet. Further, users of the online platform 100 may include relevant parties such as, but not limited to, end users, administrators, manufacturers and so on. Accordingly, in some instances, electronic devices operated by the one or more relevant parties may be in communication with the platform 100.

A user 112, such as the one or more relevant parties, may access online platform 100 through a web based software application or browser. The web based software application may be embodied as, for example, but not be limited to, a website, a web application, a desktop application, and a mobile application compatible with a computing device 2300.

FIG. 2 is a block diagram of a lighting apparatus 200, in accordance with some embodiments. The lighting apparatus 200 may include one or more of a voltage regulator 202, a plurality of illumination means 204, one or more motion sensors 206, an ancillary sensor 208, a plurality of switches 210 and a processor 212.

The voltage regulator 202 may be configured to provide a supply of electricity to the lighting apparatus 200. Further, the plurality of illumination means 204 electrically coupled to the voltage regulator 202. Further, the processor 212 may be electrically coupled to each of the plurality of illumination means 204, the one or more motion sensors 206, the ancillary sensor 208 and the plurality of switches 210.

Further, the plurality of illumination means 204 may be configured to generate light emission. Further, the one or more motion sensors 206 may be configured for detecting a motion in a vicinity of the lighting apparatus 200. Further, the ancillary sensor 208 may be configured to detect a characteristic of environmental light. Further, the plurality of switches 210 may be configured to control operation of the plurality of illumination means 204. Further, the processor 212 may be configured to control operation of the plurality of illumination means 204 based on the motion, the characteristic of environmental light and a plurality of outputs of the plurality of switches 210.

In some embodiments, the plurality of illumination means 204 may be configured to operate in one or more of an accent light mode and a security light mode. Further, an illumination means of the plurality of illumination means 204, operating in the accent light mode, may be configured to generate light emission based on the characteristic of environmental light. In the accent light mode, a low intensity light may be generated. Further, the plurality of illumination means 204, operating in the security light mode, may be configured to generate light emission at maximum intensity based on the characteristic of environmental light and detection of motion by the one or more motion sensors 206.

In further embodiments, the processor 212 may include a timing means configured for generating a timing signal. Further, the accent light mode may be associated with an accent light period and the security light mode may be associated with a security light period. Further, the plurality of illumination means 204 may be configured to remain operational for the accent light period for an arbitrary period of time prior to a security light period. Further, the plurality of illumination means 204 may be configured to remain operational for the security light period subsequent to detection of the motion.

In an exemplary embodiment, the characteristic of environmental light may include an intensity. Further, the plurality of illumination means 204 may be configured to remain operational for one or more of the accent light period and the security light period based on the intensity being below a predetermined threshold corresponding to dusk.

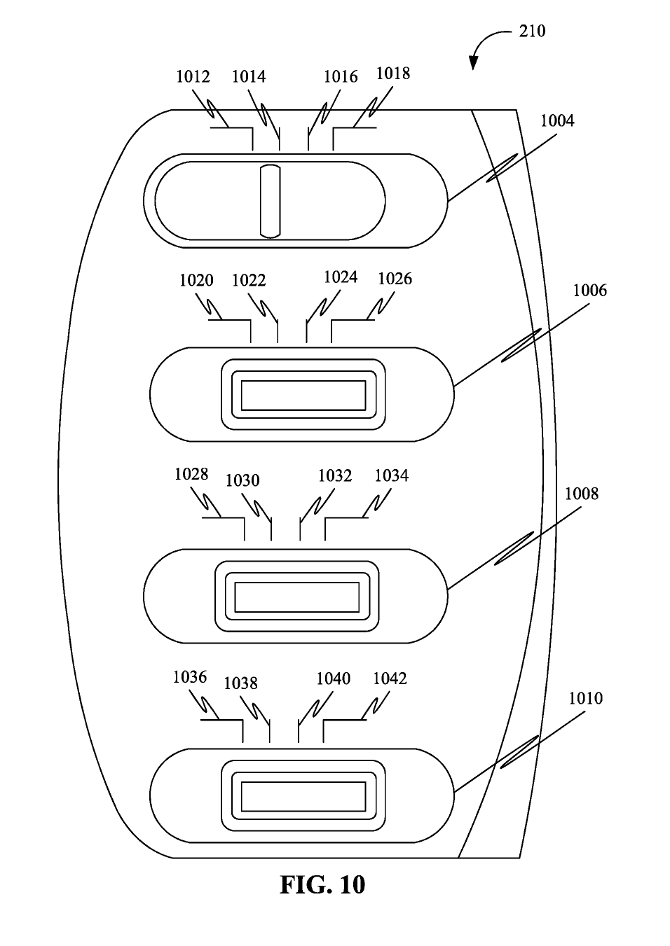

In some embodiments, the plurality of switches 210 may include an accent timer switch (such as a switch 1004 shown in FIG. 10) configured to control the accent light period. Further, the accent timer switch may be configured to provide an option of selecting a Dawn-to-Dusk (D2D) mode. Further, the plurality of light illumination means 204, in the D2D mode, may be configured to remain operational regardless of the motion and the characteristic of the environmental light.

In some embodiments, the plurality of switches 210 may include a security timer switch (such as a switch 1008 shown in FIG. 10) configured to control the security light period. Further, the security timer switch may be configured to provide an option to test operation of the plurality of light illumination means based on detection of the motion, regardless of the characteristic of environmental light. Further, the plurality of light illumination means may be configured to generate light emission for a predetermined duration of time starting from a time corresponding to the detection of the motion.

In some embodiments, the plurality of switches 210 may include a color temperature switch (such as a switch 1006 shown in FIG. 10) configured to vary a correlated color temperature (CCT) of the plurality of illumination means 204. Further, the plurality of illumination means 204 may be configured to permit a variation of light emission corresponding to one or more of warm white, soft white, bright white, and daylight based on an output of the color temperature switch.

In some embodiments, the plurality of switches 210 may include a sensitivity switch (such as a switch 1010 shown in FIG. 10). Further, the one or more motion sensors 206 may be configured to operate with a level of sensitivity based on an output of the sensitivity switch.

In some embodiments, the lighting apparatus 200 may further include a relay electrically coupled to the processor 212. Further, the relay may be configured to perform communication with one or more of a personal computing device and a remote control. Further, the relay may be further configured to control a state of the plurality of switches 210 based on the communication. Further, the relay may be configured to communicate over a wireless communication channel. Further, one or more of the personal computing device and the remote control may be configured to present a graphical user interface (GUI) comprising graphical control elements similar to an appearance of the plurality of switches 210.

In some embodiments, the lighting apparatus 200 may further include a manual override switch electrically coupled to the processor 212. Further, an activation of the manual override switch causes the plurality of illumination means 204 to operate regardless of the motion and the characteristic of the light.

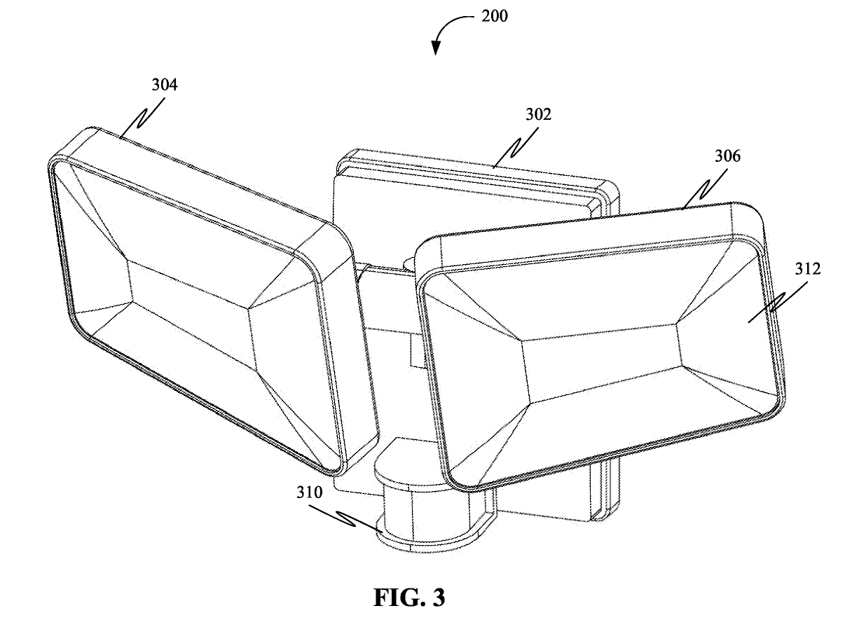

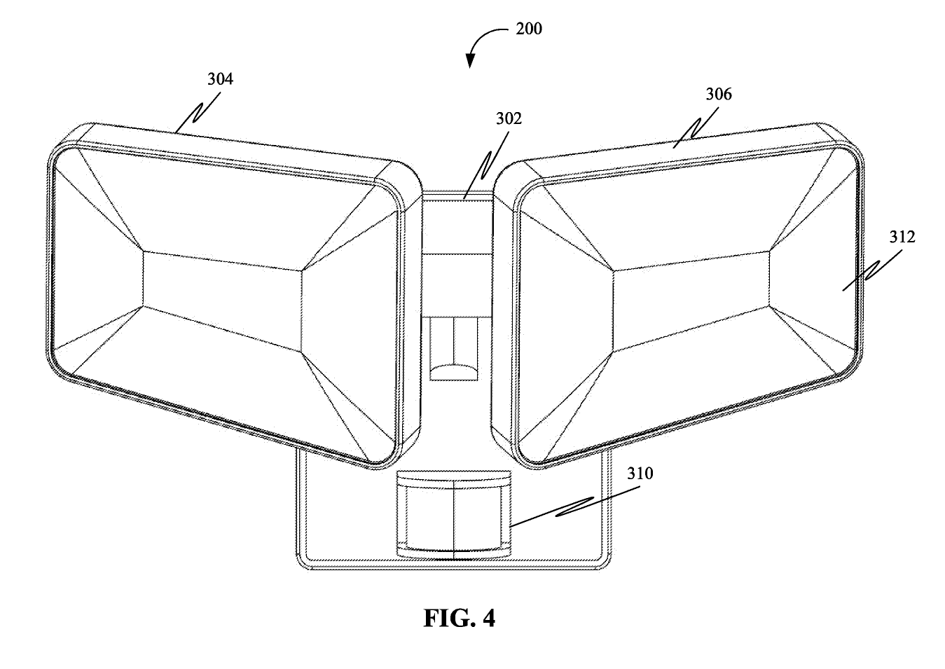

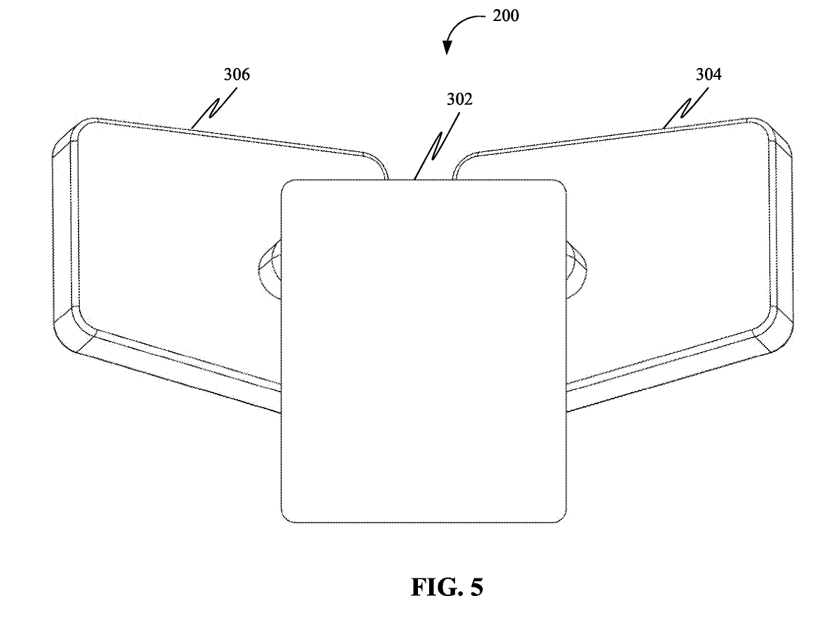

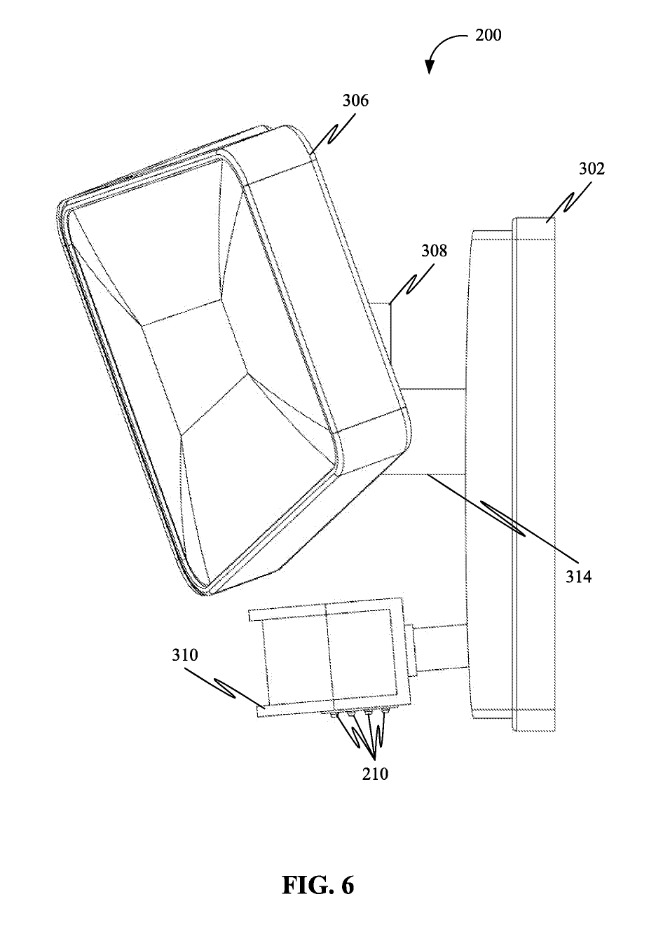

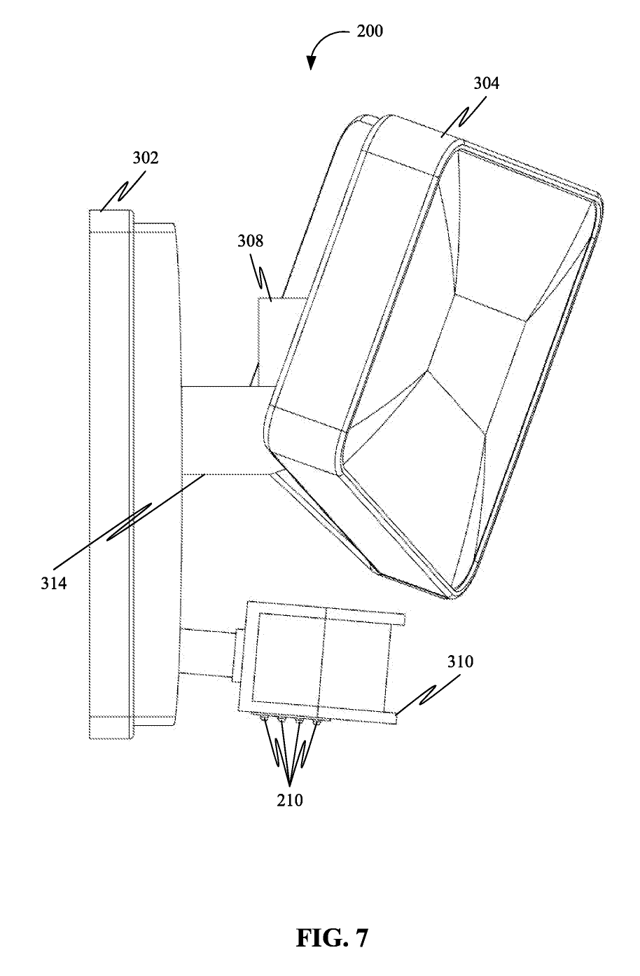

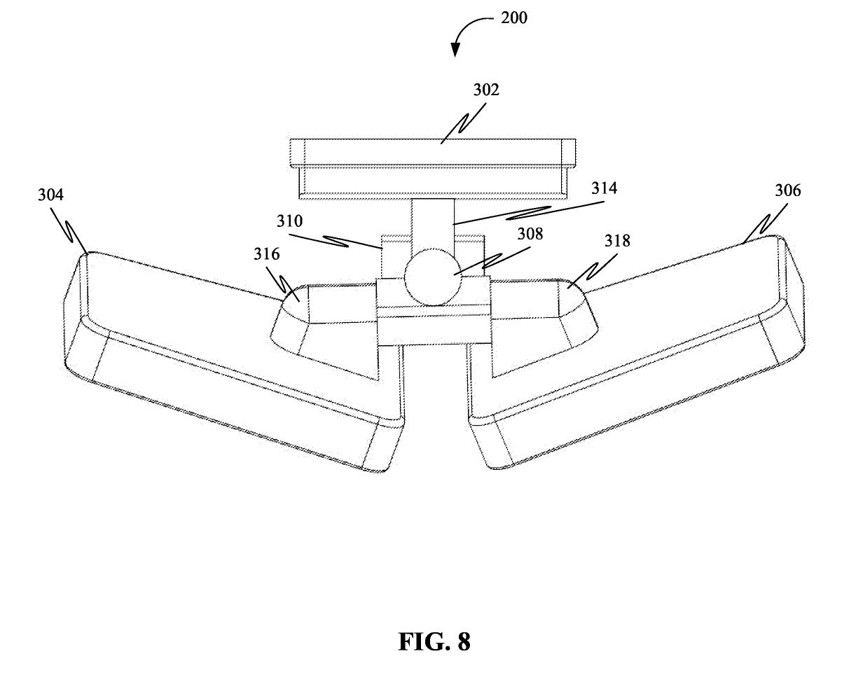

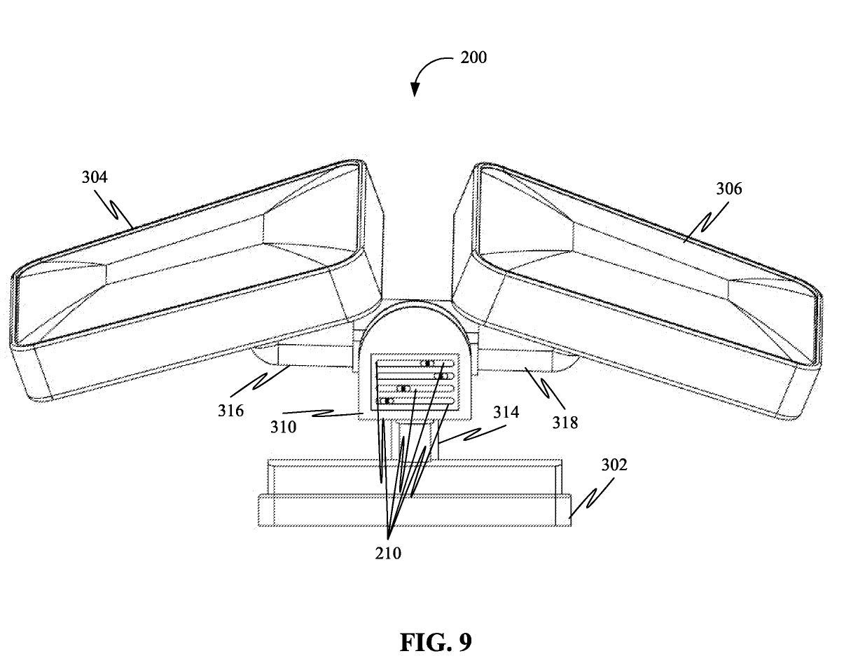

FIG. 3 is a perspective view of the lighting apparatus 200, in accordance with further embodiments. FIG. 4 is a front view of the lighting apparatus 200. FIG. 5 is a rear view of the lighting apparatus 200. FIG. 6 is a right side view of the lighting apparatus 200. FIG. 7 is a left side view of the lighting apparatus 200. FIG. 8 is a top view of the lighting apparatus 200. FIG. 9 is a bottom view of the lighting apparatus 200.

Further, the lighting apparatus 200 may further include a wall-eave mount 302 configured to be affixed to a surface, such as for example, but not limited to, that of a wall, a ceiling, or any other object (e.g. an electrical junction box), a plurality of light housings 304-306 configured to house the plurality of illumination means 204 and a pivot joint 308 configured to couple the plurality of light housings to the wall-eave mount 302. Further, the pivot joint 308 may be configured to permit pivotal motion of the plurality of light housings 304-306 in relation to the wall-eave mount 302. The wall-eave mount 302 may be affixed to a wall or a ceiling. Further, the lighting apparatus 200 may include a sensor housing 310 configured to house each of the one or more motion sensors 206 and the ancillary sensor 208.

In some embodiments, the pivot joint 308 further may include a mount protrusion 314 and a plurality of housing-pivot protrusions 316-318, wherein the mount protrusion 314 may be connected to the wall-eave mount 302 and plurality of housing-pivot protrusions 316-318 may be connected to the plurality of light housings 304-306 respectively.

In some embodiments, the plurality of light housings 304-306 may further include a lighting lens configured to diffuse light emission from an illumination means comprised in the plurality of light housings. As shown in FIG. 3, a lighting lens 312 may be included the light housing 306.

Further, FIGS. 6, 7, 9 show the plurality of switches 210 protruding beneath the sensor housing 310.

In further embodiments, the wall-eave mount 302 further may include an electrical junction box fastener configured to permit affixing of the wall-eave mount 302 to an electrical junction box, a power aperture configured to permit passage of a cable in connection to an extraneous domicile switch, and the mount protrusion 314 including a protrusion aperture. Further, the pivot joint 308 may further include a plurality of housing-pivot apertures. Further, the plurality of light housings 304-306 may include a lighting recess that itself still further comprises the lighting lens (such as the lens 312).

Further, the wall-eave mount 302 may be administered directly to an electrical junction box that itself is affixed to the wall or eave of a domicile. Further, the wall-eave mount 302 may possess a rectilinear planar surface or configuration thereof with a partly hollow interior or passage that leads through the body of the wall-eave mount 302 to the sensor housing 310 and the protrusion aperture. The wall-eave mount 302 may further house the voltage regulator 202 and the processor 212 arbitrarily therein through conventional mounting or fastening means. While the wall-eave mount 302 may possess a generally rectilinear geometry, the wall-eave mount 302 may possess any number of geometries including, but not limited to curvilinear, trilinear, polygonal, and so on where the mount protrusion 314 may generally originate from the center and the sensor housing 310 secured thereunder along the vertical center of the front facing planar surface.

Further, the electrical junction box fastener located on the rear surface of the wall-eave mount 302 may permit affixing thereof to the exterior wall or eave of the domicile. It may be further appreciated that the electrical junction box fastener may permit affixing of the wall-eave mount 302 to an electrical junction box directly. The electrical junction box fastener may be presented in a plurality thereof or through a single bracketed means of affixing that may include, but is not limited to conventional fasteners, screws, bolts, adhesives, suction, magnetics, snap fits, self-locating geometry and so on. Preferably on the rear surface of the wall-eave mount 302 and in connection and open to the cavity therein is the power aperture that may permit the passage of a cable or wire that is in connection to the extraneous domicile switch, thus permitting activation of the lighting apparatus 200 through the flip of a conventional switch, knob, slider, or other domicile interior oriented switch. The power aperture may be curvilinear in shape, however, the geometry may vary relevant to the cable to restrict the permeation of water into the interior cavity and the passages thereof. Further, the power aperture may be located on the bottom edge of the wall-eave mount 302 or along the longitudinal edge surfaces.

Further, located along the horizontal center protruding from the front surface of the wall-eave mount 302 is the sensor housing 310. The sensor housing 310 may be located an arbitrary distance below the mount protrusion 314 where a preferably curvilinear sensor permeable surface is front facing and a passage for the transmission of a cable to run there through is located at the rear. The sensor housing 310 may house the one or more sensors therein and house the plurality of switches 210 on the bottom surface of the sensor housing 310. Protruding from the horizontal center and above the sensor housing 310 is the mount protrusion 314. The mount protrusion 314 may provide a non-descript span of distance to permit the pivot joint 308 to rotate at least 30 degrees along the vertical axis.

Further, bored vertically through the distal end of the mount protrusion 314 is the protrusion aperture. The protrusion aperture may not be bored through and may possess a means of affixing the mount-pivot protrusion therein and further possess an aperture or passage that permits the passage of cables therein through the pivot joint 308.

Further, the pivot joint 308 may engage the mount protrusion 314 through the mount-pivot protrusion and may provide at least 30 degrees of rotation about the vertical axis and at least 30 degrees' rotation about the horizontal axis relevant to the pivot joint 308. In essence, the pivot joint 308 may form the juncture between the wall-eave mount 302 and the plurality of light housings 304-306. Further, protruding from the bottom surface of the pivot joint 308 near the rear thereof is the mount-pivot protrusion, wherein the mount-pivot may engage the protrusion aperture to achieve the at least 30 degrees of rotation about the vertical axis. Protruding from the lateral surfaces of the pivot joint 308 outward in a preferable rod or axle shape is the plurality of housing-pivot apertures. The plurality of housing-pivot apertures may be two in count and share the same rotation about the vertical axis. Further, the plurality of housing-pivot aperture may engage the housing-pivot protrusion (in the housing-pivot protrusions 316-318) to permit at least 30 degrees of rotation about the horizontal axis relevant to the pivot joint 308 to angle and direct the light emitted by the light housings 304-306.

Further, in connection to the pivot joint 308 is the plurality of light housings 304-306, where the individual housing thereof may be secured through the housing-pivot protrusion (in the housing-pivot protrusions 316-318) to the appropriate housing-pivot aperture. The plurality of light housings 304-306 may further possess a passage therein that may permit transmission of a cable from the wall-eave mount 302 and the voltage regulator 202 to the individual illumination means. Further, the plurality of light housings 304-306 may be constituted of a count of two with one relegated to an individual housing-pivot aperture. Protruding from the rear surface of the individual light housing is the housing-pivot protrusion (in the housing-pivot protrusions 316-318). Wherein the housing pivot protrusion may be angled a non-descript number of degrees from the planar surface along the horizontal plane, thus rendering the angle between the lighting lens into a reflex angle. The housing-pivot protrusion may further preferably possess a means of fastening into the respective housing-pivot aperture.

Further, formed within the geometric confines of the individual lighting housing with a geometrically uniform cavity is the lighting recess. The illumination means may be secured within the lighting recess through conventional fastening means. Further, the lighting recess may house the lighting lens (such as the lens 312) and possess an aperture that permits the passage of the illumination means through the aperture thereof. Secured along the perimeter of the lighting recess near the front surface or lip of the individual lighting housing is the lighting lens that may diffuse or spread the emission of light from the illumination means housed within the lighting recess. The lighting lens may be secured through conventional fastening means such as, but not limited to conventional screws, bolts, snap fits, self-orienting geometry, and so on.

Further, the lighting apparatus 200 may include an electrical system that may receive a voltage from a domicile's power grid and receive activation through an extraneous domicile switch. The electrical system may primarily be housed within the wall-eave mount 302, sensor housing 310, and the plurality of light housings 304-306 with cable passages there between.

Further, arbitrarily housed within the wall-eave mount 302, and in connection to the processor 212 and the plurality of illumination means 204 alongside the domicile's power system is the voltage regulator 202 that may manage the supply of electricity to and throughout the system. Housed within the plurality of light housings 304-306, within the lighting recess, and behind the lighting lens is the plurality of illumination means 204. The plurality of illumination means 204 may comprise a single bulb or a cluster of illumination means including bulbs, tubes, LEDs, and so on. The plurality of illumination means 204 may be composed of a count equal to the plurality of light housings 304-306, or else greater and clustered arbitrarily on the front facing surface of the lighting recess of the individual light housing. Preferably, the plurality of illumination means 204 may permit the variation of illumination emitted thereof with values corresponding with warm white, soft white, bright white, and daylight that may be conducive to the output of the color temperature switch. Further, the plurality of illumination means 204 through the processor 212 and plurality of switches 210 may operate independently as either an accent lighting apparatus corresponding to the accent timer switch setting, or as a security lighting apparatus through operation and reception of the one or more motion sensors 206.

Further, housed arbitrarily in the wall-eave mount 302 body and the cavity therein is the processor 212 that may interpret and facilitate the control of the lighting apparatus 200 through the plurality of switches 210 and the optional relay. The processor 212 may further possess a timing means and process concurrent thereof wherein a user may set the lighting apparatus 200 at dusk and the security light protocol may operate through a single night before requiring reset the proceeding day. Further, the operation of the security/accent lighting protocol may operate through an ancillary sensor 208 that can detect the intensity of environmental light from dusk to dawn, thereby facilitating the activation of the security light and persistence of the accent light. The lighting apparatus 200 may further permit a nocturnal cycle of continuous operation that runs off of an internal clock of the processor 212, or permit interaction from the user through the optional relay and the personal computing device interface accessed through a user's extraneous personal computing device or remote control.

Further, housed within the sensor housing 310 is the one or more motion sensors 206 that may provide for a field of sensory reception, preferably in a range of 120-240 degrees that is directed toward the ground beneath the wall-eave mount 302. The range of the one or more motion sensors 206 may also preferably be variable between a range of 5 to 80 feet that is conducive to the sensitivity switch of the plurality of switches 210. Further, the one or more motion sensors 206 may offer a pre-defined collection of values or all values there between through a slider switch or similar means of a variable input.

Further, secured on the underside of the sensor housing 310 is the plurality of switches 210 that may provide the requisite input to the lighting apparatus 200 to alter the settings thereof. Further, the plurality of switches 210 may be composed of a count of four or greater and aligned linearly and parallel to one another on the underside surface of the sensor housing 310, as shown in FIG. 10. The plurality of switches 210 may be present in a slider (as shown in the switch 1004) form that has a pre-selection of values set for the operation of the illumination means, timer, and sensor sensitivity.

Further, the plurality of switches 210 may include sensitivity switch that may provide a means of setting the level of sensitivity and thus the range of the one or more motion sensors 206 along a range of values between 5 and 80 feet. Further, an accent timer switch may be included in the plurality of switches 210 that may be used to adjust the span of time the accent light on timer will operate for. The time may be measured in hours, operating from dusk to dawn through an ancillary sensor 208 that can detect the intensity of environmental light, or else through the internal timer of the processor 212. A security timer switch may be included in the plurality of switches 210 that may control the span of time the security light is illuminated after the accent light mode has ended and motion is detected by the one or more motion sensors 206. Through the security timer switch, an option to test the lighting may be offered that may illuminate the fixture at full power for an arbitrary number of seconds when motion is detected by the one or more motion sensors 206 regardless of the time of day conducive to the optimum level of sensitivity selected by the user. Further, a color temperature switch may be included in the plurality of switches 210 that may control the correlated color temperature (CCT) of the plurality of illumination means 204 with a range that may be conducive to the color temperature where the slider may provide indicia conducive to relaying warm white, soft white, bright white, and daylight that is related to a color temperature scale of 2200, 3000, 4000, and 5000 Kelvin respectively.

Optionally, a relay may be provided that permits the processor 212 to be accessed from a distance through the user's phone, personal computing device, or remote control, wherein a personal computing device or remote control interface may be provided that allows them to engage and circumvent the physical interaction of the plurality of switches 210 or the extraneous domicile switch. Further, personal computing device interface may couple with the optional relay through a Bluetooth, or other wireless transmission means where signals sent there between may be facilitated through the optional relay. Further, the personal computing device interface or remote control may permit the user to engage the processor 212 of the lighting apparatus 200 from the comfort of their phone or a remote control as opposed to the lighting apparatus 200, which may be installed at a high point along the domicile's wall or conveniently indoors. The personal computing device or remote control interface may be designed similar to the plurality of switches 210. The personal computing device may digitally prompt the individual and be dismissed by the closure of the program through the personal computing device.

Further, extraneous to the lighting apparatus 200 but ancillary to the function thereof is the extraneous domicile switch that may be located on the interior or exterior of the domicile and in connection to the lighting apparatus 200 through cables that span through the power aperture of the wall-eave mount 302, where the cable may secure through the voltage regulator 202 to the processor 212. The extraneous domicile switch may form the primary shut off and activation switch of the lighting apparatus 200. Alternatively, the lighting apparatus 200 may only require an internal shut off and activation switch if the optional relay is employed.

FIG. 10 is a front view of the plurality of switches 210, in accordance with some embodiments. The plurality of switches 210 includes an accent timer switch 1004, a color temperature switch 1006, a security timer switch 1008, and a sensitivity switch 1010.

The accent timer switch 1004 may be configured to control the accent light period. The accent timer switch 1004 may offer a pre-defined collection of values through a slider switch. The pre-defined collection of values may include one or more of an “off” value 1012, a “3 hr” value 1014, a “6 hr” value 1016 and a “Dawn-to-Dusk (D2D)” value 1018. When the “off” value 1012 is selected, the plurality of illumination means 204 may be switched off in the accent light mode. When the “3 hr” value 1014 is selected, the plurality of illumination means 204 may be switched on for 3 hours in the accent light mode. When the “6 hr” value 1016 is selected, the plurality of illumination means 204 may be switched on for 6 hours in the accent light mode. When the “D2D” value 1018 is selected, the plurality of light illumination means 204 may be configured to remain operational regardless of the motion and the characteristic of the environmental light.

Further, the color temperature switch 1006 may be configured to vary a correlated color temperature (CCT) of the plurality of illumination means 204. The color temperature switch 1006 may offer a pre-defined collection of colors through a slider switch. The pre-defined collection of colors may include one or more of a “Warm White (WW)” color 1020, a “Soft White (SW)” color 1022, a “Bright White (BW)” color 1024, and a “Day-Light (DL)” color 1026.

Further, the security timer switch 1008 may be configured to control the security light period. The security timer switch 1008 may offer a pre-defined collection of values through a slider switch. The pre-defined collection of values may include one or more of a “test” value 1028, a “1 min” value 1030, a “5 min” value 1032 and a “20 min” value 1034. A user may select the test” value 1028 is selected to test operation of the plurality of light illumination means based on detection of the motion, regardless of the characteristic of environmental light. Further, the plurality of light illumination means may be configured to generate light emission for a predetermined duration of time starting from a time corresponding to the detection of the motion. The user may select the predetermined duration of time by selecting one of the “1 min” value 1030, the “5 min” value 1032 and the “20 min” value 1034.

Further, the sensitivity switch 1010 may be configured to control the level of sensitivity of the one or more motion sensors 206. The sensitivity switch 1010 may offer a pre-defined collection of values through a slider switch. The pre-defined collection of values may include one or more of a “5 feet” value 1036, a “30 feet” value 1038, a “50 feet” value 1040 and an “80 feet” value 1042.

According to some embodiments, the lighting apparatus 200 is disclosed. The lighting apparatus 200 may include the wall-eave mount 302 configured to be affixed to a surface (or electrical junction box). The lighting apparatus 200 may include the plurality of light housings 304-306, the pivot joint 308 configured to couple the plurality of light housings 304-306 to the wall-eave mount 302. Further, the pivot joint 308 may be configured to permit pivotal motion of the plurality of light housings 304-306 in relation to the wall-eave mount 302. Further, the lighting apparatus 200 may include the voltage regulator 202 configured to provide supply of electricity to the lighting apparatus 200. Further, the lighting apparatus 200 may include the plurality of illumination means 204 electrically coupled to the voltage regulator 202. Further, the plurality of illumination means 204 may be configured to generate light emission. Further, the plurality of light housings 304-306 may be configured to house the plurality of illumination means 204. Further, the lighting apparatus 200 may include the one or more motion sensors 206 configured for detecting a motion in a vicinity of the lighting apparatus 200. Further, the lighting apparatus 200 may include the ancillary sensor 208 configured to detect a characteristic of environmental light.

Further, the lighting apparatus 200 may include the plurality of switches 210 configured to control operation of the plurality of illumination means 204.

Further, the lighting apparatus 200 may include processor 212 electrically coupled to each of the plurality of illumination means 204, the one or more motion sensors 206, the ancillary sensor 208 and the plurality of switches 210. Further, the processor 212 may be configured to control operation of the plurality of illumination means 204 based on the motion, the characteristic of environmental light and a plurality of outputs of the plurality of switches 210. Further, the plurality of illumination means 204 may be configured to operate in one or more of an accent light mode and a security light mode. Further, an illumination means of the plurality of illumination means 204, operating in the accent light mode, may be configured to generate light emission based on the characteristic of environmental light. In the accent light mode, a low intensity light may be generated. Further, the plurality of illumination means 204, operating in the security light mode, may be configured to generate light emission at maximum intensity based on the characteristic of environmental light and detection of motion by the one or more motion sensors 206.

Further, the processor 212 may further include a timing means configured for generating a timing signal, wherein the accent light mode is associated with an accent light period and the security light mode is associated with a security light period, wherein the plurality of illumination means is configured to remain operational for the accent light period for an arbitrary period of time prior to a security light period, wherein the plurality of illumination means is configured to remain operational for the security light period subsequent to detection of the motion.

Further, the characteristic may include an intensity, wherein the plurality of illumination means is configured to remain operational for at least one of the accent light period and the security light period based on the intensity being below a predetermined threshold corresponding to dusk.

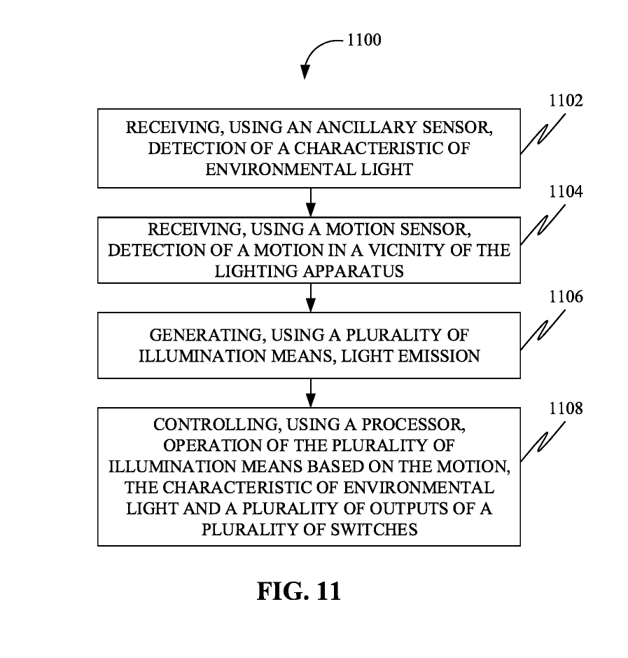

FIG. 11 is a flowchart of a method 1100 for operating a lighting apparatus (such as the lighting apparatus 200) in accordance with some embodiments. At 1102, the method 1100 may include receiving, using an ancillary sensor (such as the ancillary sensor 208), detection of a characteristic of environmental light.

Further, at 1104, the method 1100 may include receiving, using a motion sensor (such as the one or more motion sensors 206), detection of a motion in a vicinity of the lighting apparatus.

Further, at 1106, the method 1100 may include generating, using a plurality of illumination means (such as the illumination means 204), light emission.

Further, at 1108, the method 1100 may include controlling, using a processor (such as the processor 212), operation of the plurality of illumination means based on the motion, the characteristic of environmental light and a plurality of outputs of a plurality of switches (such as the plurality of switches 210), wherein the plurality of illumination means is configured to operate in at least one of an accent light mode and a security light mode, wherein an illumination means of the plurality of illumination means, operating in the accent light mode, is configured to generate light emission based on the characteristic of environmental light, wherein the plurality of illumination means, operating in the security light mode, is configured to generate light emission at maximum intensity based on the characteristic of environmental light and detection of motion by the motion sensor. In the accent light mode, a low intensity light may be generated.

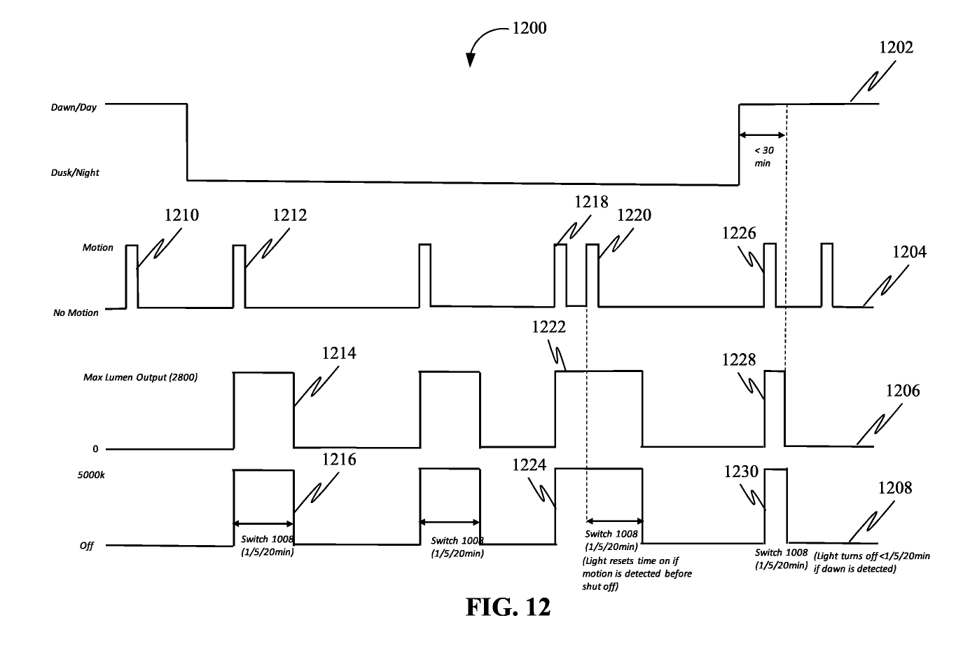

FIG. 12 is timing diagram 1200 illustrating operation of the lighting apparatus 200, in accordance with an exemplary embodiment. The timing diagram 1200 may be related to a scenario where the lighting apparatus 200 operates as an on/off switch with motion security light, with no accent light operation.

A signal 1202 may be received from a photo cell. The signal 1202 may indicate one of a day time or a night time. A signal 1204 may be received from the one or more motion sensors 206. A signal 1206 may be related to color temperature of light emitted by the illumination means 204. The user may select the color temperature using color temperature switch 1006. For example, the user may choose the “Day-Light (DL)” color 1026 (corresponding to 5000K). A signal 1208 may be related to the time of illumination of the illumination means 204. The user may select the time of illumination using the security timer switch 1008. For example, the user may select one of the “1 min” value 1030, the “5 min” value 1032 and the “20 min” value 1034.

A pulse 1210 (in the signal 1204) indicates detection of motion. However, the signal 1202 indicates that it is still daytime; therefore, the illumination means 204 is not activated as shown by the signals 1206-1208.

At a later point of time, a pulse 1212 (in the signal 1204) indicates detection of motion. Now, the signal 1202 indicates that it is night-time; therefore, the illumination means 204 is activated for a pre-determined time period as shown by the pulses 1214-1216 in the signals 1206-1208, respectively. The pre-determined time period may correspond to the security timer switch 1008.

At a later point of time, a pulse 1218 (in the signal 1204) indicates detection of motion. As, the signal 1202 indicates that it is night-time, the illumination means 204 is activated for a pre-determined time period as shown by the signals 1206-1208. Further, a pulse 1220 (in the signal 1204) indicates detection of motion. Since, the pre-determined time period related to the pulse 1218 has not ended when the pulse 1220 is received, therefore, the time period of activation of the illumination means 204 is reset. Accordingly, the total time period of activation of the illumination means 204 is extended as shown by pulses 1222-1224 in the signals 1206-1208, respectively.

At a later point of time, a pulse 1226 (in the signal 1204) indicates detection of motion. Further, the signal 1202 indicates that it is dawn-time, as less than 30 minutes have passed since the ending of night-time. This 30-minute period may be set by the user. Accordingly, the illumination means 204 is activated (as shown by pulses 1228-1230 in the signals 1206-1208) until one of the pre-determined time period (of the security timer switch 1008) or the 30-minute period ends.

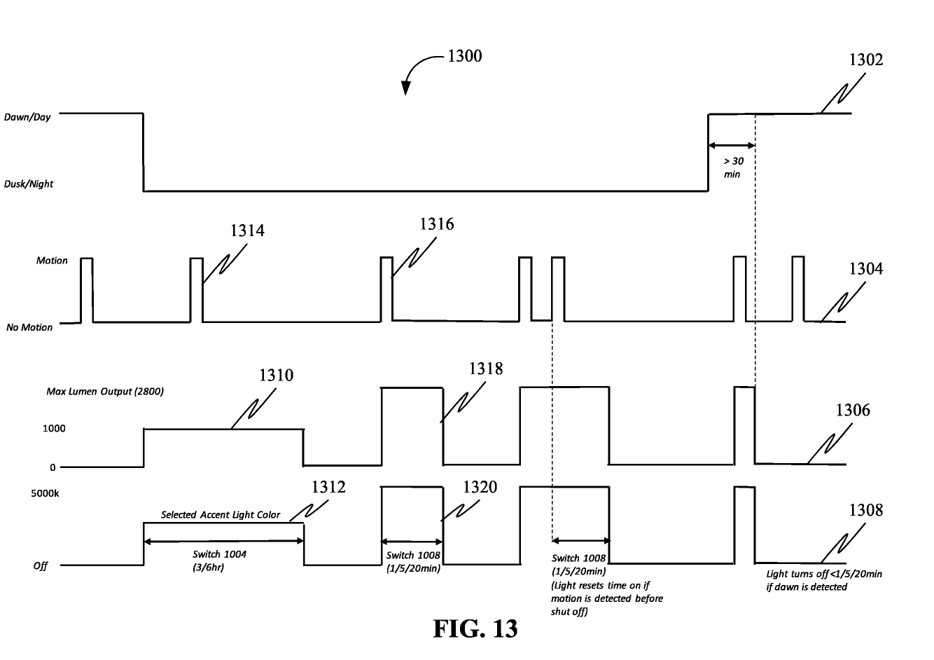

FIG. 13 is timing diagram 1300 illustrating operation of the lighting apparatus 200, in accordance with an exemplary embodiment. The timing diagram 1300 may be related to a scenario where the lighting apparatus 200 operates in accent light mode with accent light for 3/6 hr, then turns off and also operates as an off/on with motion security light.

A signal 1302 may be received from a photo cell. The signal 1302 may indicate one of a day time or a night time. A signal 1304 may be received from the one or more motion sensors 206. A signal 1306 may be related to color temperature of light emitted by the illumination means 204. The user may select the color temperature using color temperature switch 1006. For example, in the accent light mode, a soft white color temperature may be used. Further, in the security mode, a bright white color temperature may be used. A signal 1308 may be related to the time of illumination of the illumination means 204. The user may select the time of illumination using the accent timer switch 1004. For example, the user may select one of the “3 hr” value 1014 and the “6 hr” value 1016.

In accent light mode, the lighting apparatus 200 is activated when the signal 1302 indicates night-time, as shown by pulses 1310-1312 in the signals 1306-1308, respectively. The accent light mode is activated for a predetermined time period selected by the user using the accent timer switch 1004. For example, the predetermined time period may be one of the “3 hr” value 1014 and the “6 hr” value 1016.

At a later point of time, a pulse 1314 (in the signal 1304) indicates detection of motion. However, the accent light mode is still activated as shown by the pulses 1310-1312 in the signals 1306-1308; therefore, the pulse 1314 is ignored.

At a later point of time, a pulse 1316 (in the signal 1304) indicates detection of motion. Since, the accent light mode is not active as shown in the signals 1306-1308; therefore, the illumination means 204 is activated for a pre-determined time period as shown by the pulses 1318-1320 in the signals 1306-1308, respectively.

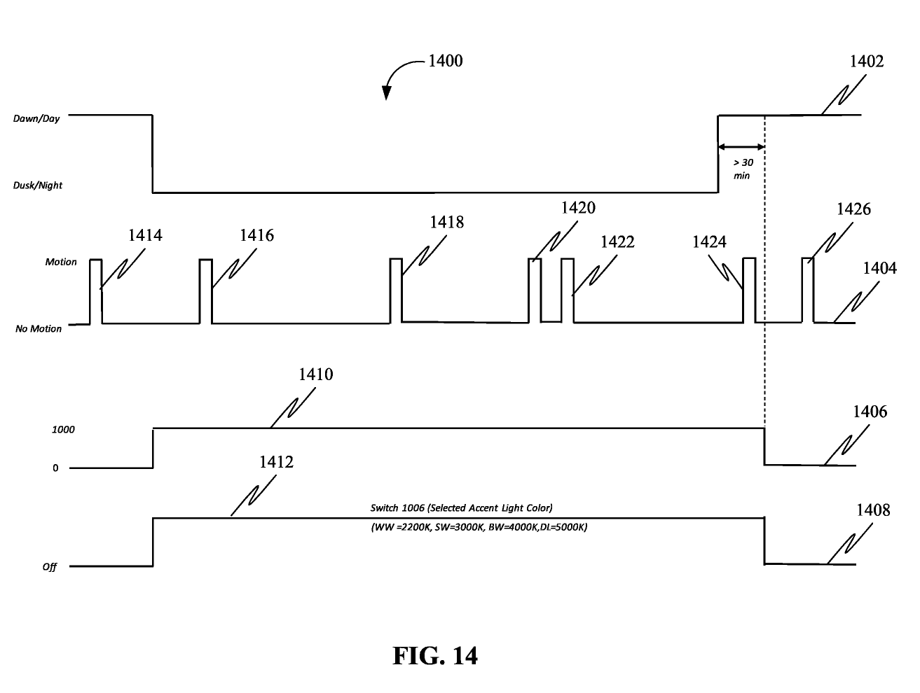

FIG. 14 is timing diagram 1400 illustrating operation of the lighting apparatus 200, in accordance with an exemplary embodiment. The timing diagram 1400 may be related to a scenario where the lighting apparatus 200 operates in accent light mode from dusk to dawn and never operates as an off/on motion security light. The user may select this scenario by selecting the “Dawn-to-Dusk (D2D)” value 1018 via the accent timer switch 1004. When the “D2D” value 1018 is selected, the plurality of light illumination means 204 may be configured to remain operational regardless of the motion and the characteristic of the environmental light.

A signal 1402 may be received from a photo cell. The signal 1402 may indicate one of a day time or a night time. A signal 1404 may be received from the one or more motion sensors 206. A signal 1406 may be related to the color temperature of light emitted by the illumination means 204. A signal 1408 may be related to the time of illumination of the illumination means 204.

When night-time is detected using the signal 1402, the illumination means 204 is activated as shown by pulses 1410-1412 in the signals 1406-1408, respectively. Further, when night-time ends, the illumination means 204 remain active for another 30 minutes.

Further, the motion is detected at various times as indicated by pulses 1414-1426 in the signal 1404. However, the pulses 1414-1426 are ignored.

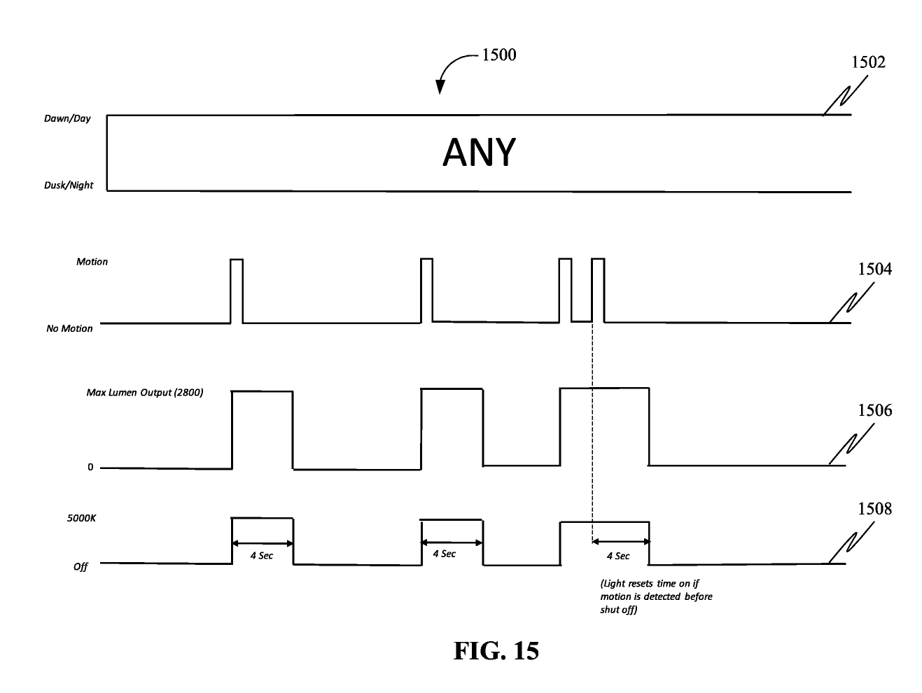

FIG. 15 is timing diagram 1500 illustrating operation of the lighting apparatus 200, in accordance with an exemplary embodiment. The timing diagram 1500 may be related to a test mode that allows a consumer to select PIR detection distance.

A signal 1502 may be received from a photo cell. The signal 1502 may indicate one of a day time or a night time. A signal 1504 may be received from the one or more motion sensors 206. A signal 1506 may be related to color temperature of light emitted by the illumination means 204. A signal 1508 may be related to the time of illumination of the illumination means 204.

As shown, in the test mode, the signal 1502 is ignored. Further, whenever motion is detected via the pulses in the signal 1504, the illumination means 204 is activated for a pre-determined time period (such as 4 seconds)

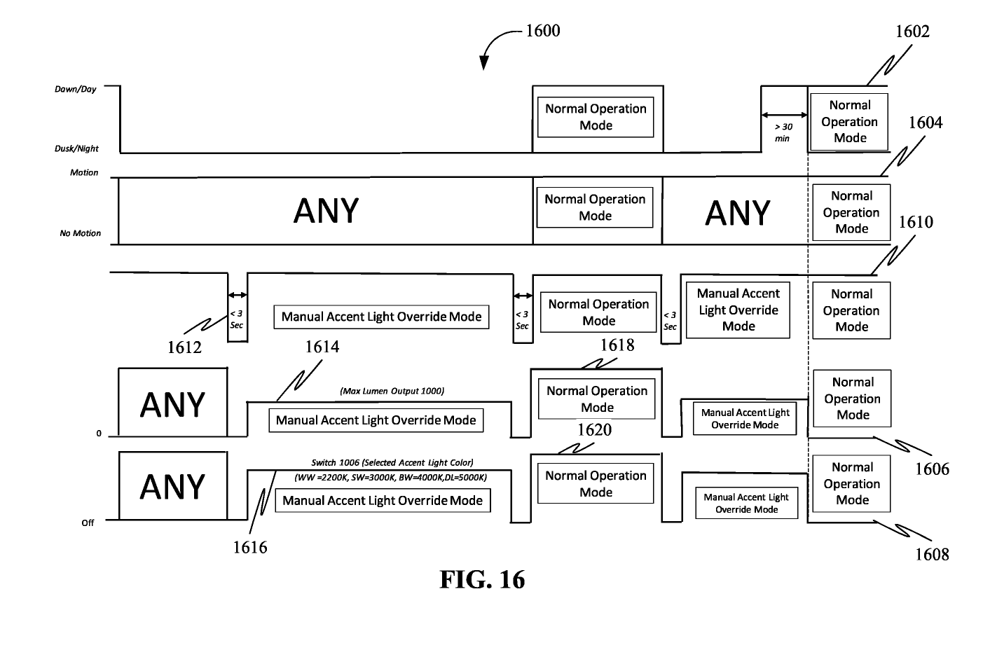

FIG. 16 is timing diagram 1600 illustrating operation of the lighting apparatus 200, in accordance with an exemplary embodiment. The timing diagram 1600 may be related to a manual accent light override mode that allows manual on/off of light.

A signal 1602 may be received from a photo cell. The signal 1602 may indicate one of a day time or a night time. A signal 1604 may be received from the one or more motion sensors 206. A signal 1606 may be related to color temperature of light emitted by the illumination means 204. A signal 1608 may be related to the time of illumination of the illumination means 204. Further, a signal 1610 may be related to AC power supplied to the lighting apparatus 200.

A user may user a switch to activate the manual accent light override mode. In this mode, the accent light is switched on for a predetermined period. The user may activate the manual accent light override mode as shown by pulse 1612 in the signal 1610. Accordingly, the illumination means 204 is activated as shown by pulses 1614-1616 in the signals 1606-1608, respectively.

After the predetermined period is over, the manual accent light override mode is deactivated and the operation returns to a normal operation mode, as shown by pulses 1618-1620 in the signals 1606-1608, respectively.

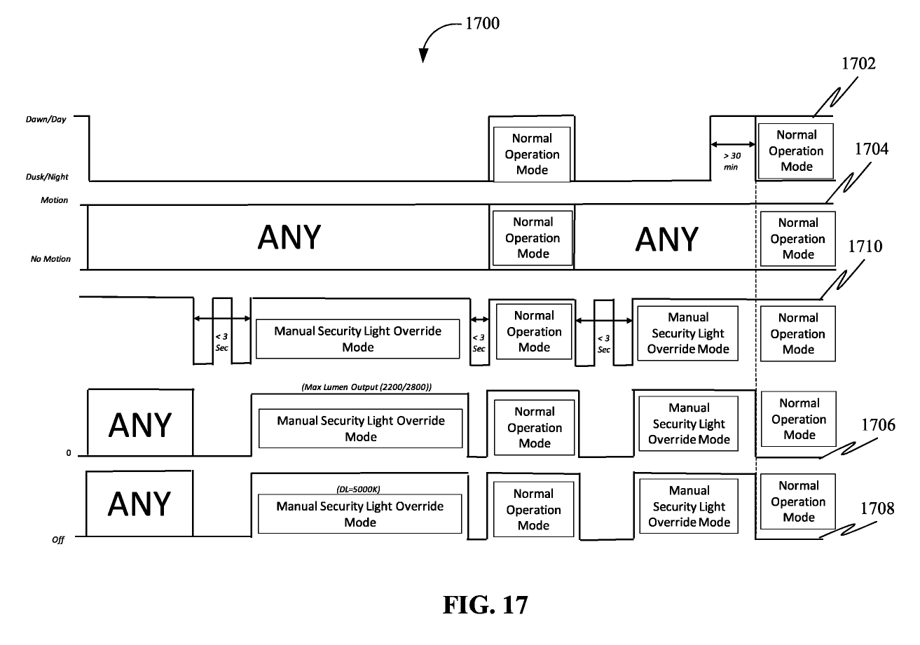

FIG. 17 is timing diagram 1700 illustrating operation of the lighting apparatus 200, in accordance with an exemplary embodiment. The timing diagram 1700 may be related to a manual security light override mode that allows manual on/off of light.

A signal 1702 may be received from a photo cell. The signal 1702 may indicate one of a day time or a night time. A signal 1704 may be received from the one or more motion sensors 206. A signal 1706 may be related to color temperature of light emitted by the illumination means 204. A signal 1708 may be related to the time of illumination of the illumination means 204. Further, a signal 1710 may be related to AC power supplied to the lighting apparatus 200.

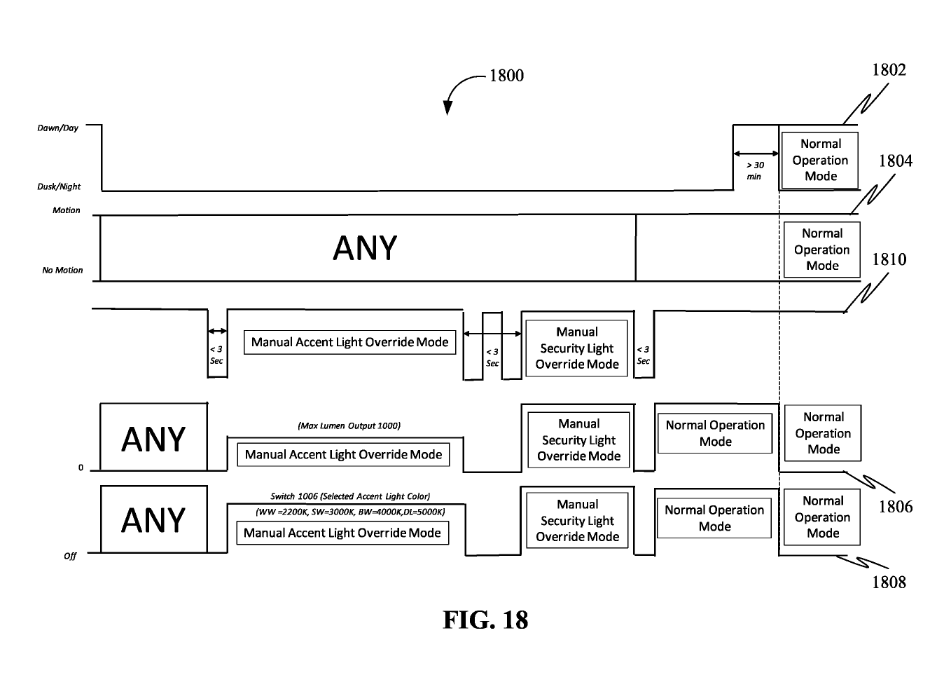

FIG. 18 is timing diagram 1800 illustrating operation of the lighting apparatus 200, in accordance with an exemplary embodiment. The timing diagram 1800 may be related to a manual accent light override mode that allows manual on/off of light to manual security light override mode.

A signal 1802 may be received from a photo cell. The signal 1802 may indicate one of a day time or a night time. A signal 1804 may be received from the one or more motion sensors 206. A signal 1806 may be related to color temperature of light emitted by the illumination means 204. A signal 1808 may be related to the time of illumination of the illumination means 204. Further, a signal 1810 may be related to AC power supplied to the lighting apparatus 200.

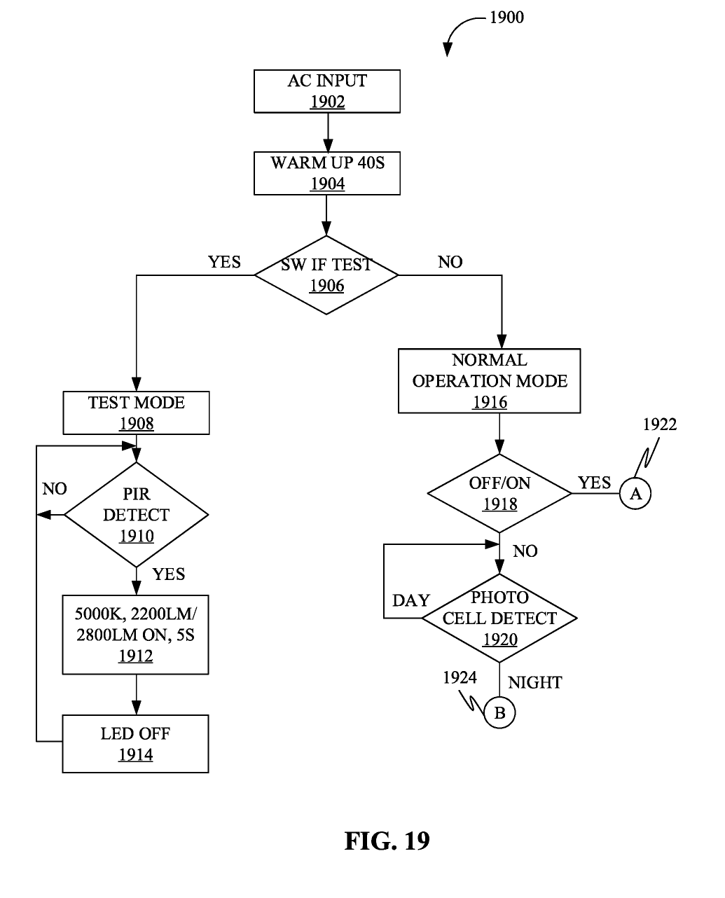

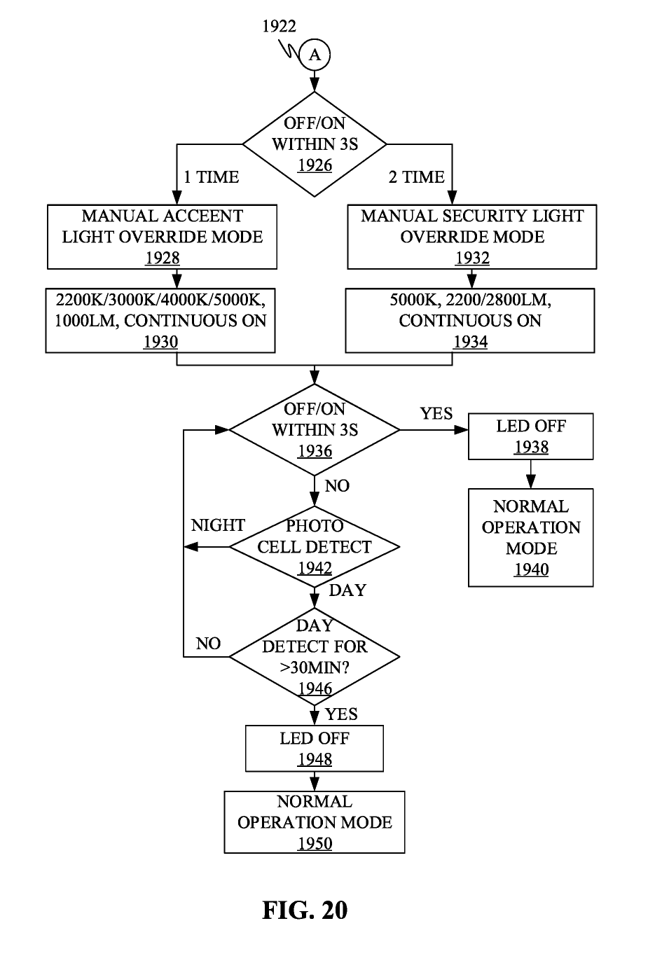

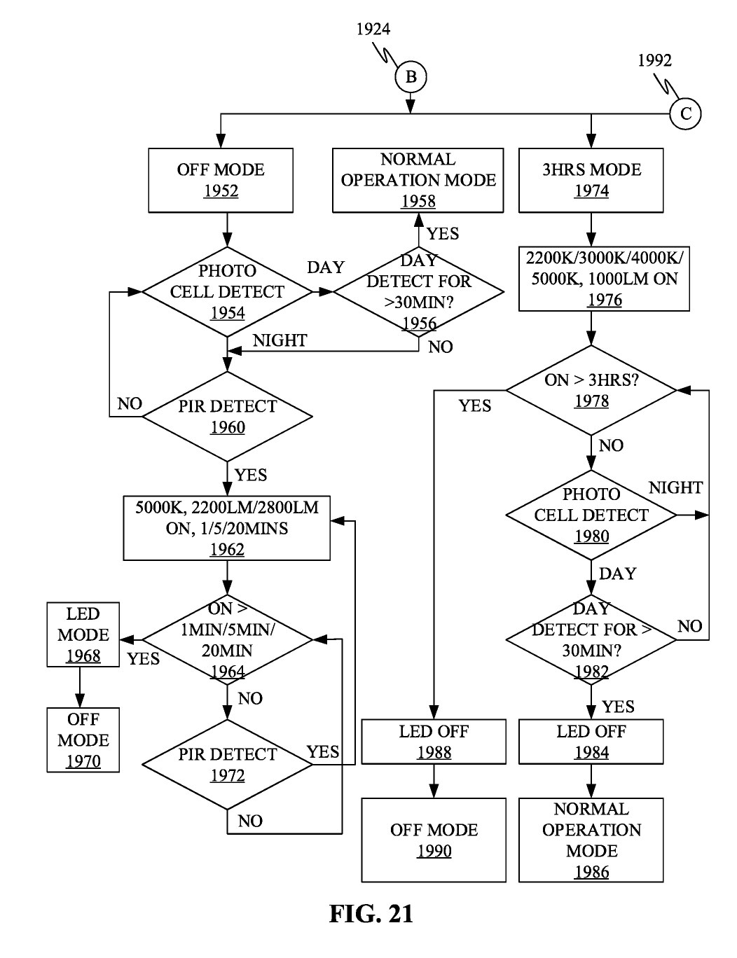

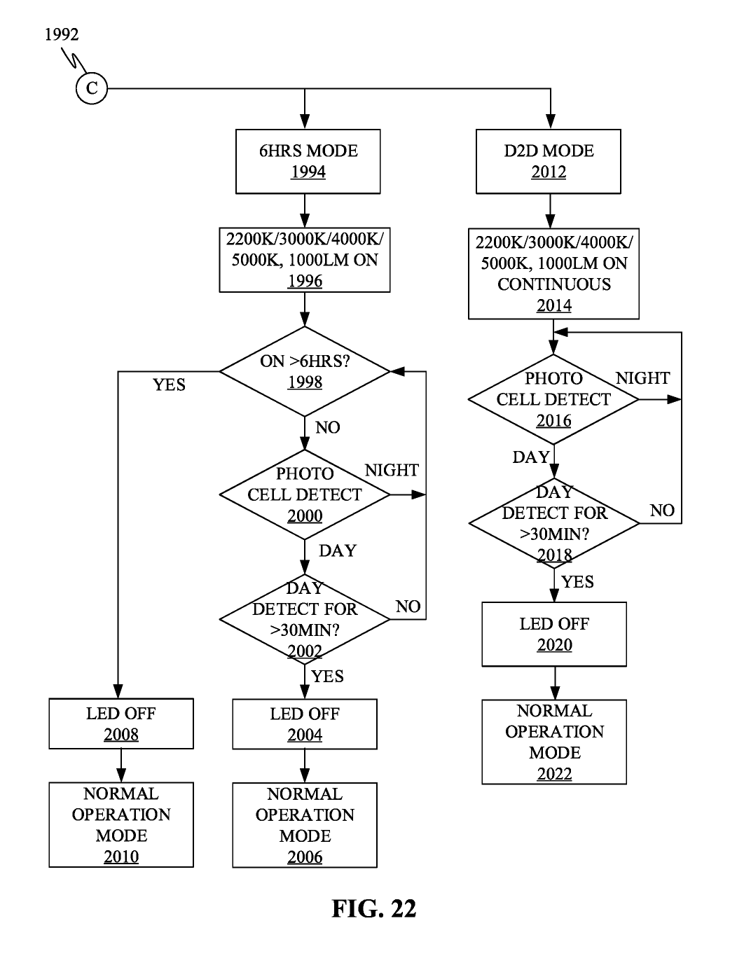

FIGS. 19-22 illustrate a flow chart of a method 1900 for operating a lighting apparatus (such as the lighting apparatus 200) in accordance with some embodiments. At 1902, the method 1900 may include receiving AC input. Further, at 1904, the method 1900 may include performing warm up for 40 seconds. Further, at 1906, the method 1900 may include performing SW if test. If the SW test results positive, then at 1908, the method 1900 may include beginning test mode. Further, at 1910, the method 1900 may include performing detecting PR (motion). If PR is not detected at 1910, the method 1900 may include repeating step 1910. If PIR is detected at 1910, then at 1912, the method 1900 may include checking if 5000K, or 2200LM/2800LM are on for 5 seconds.

Further, at 1914, the method 1900 may include turning light off, and repeating the method 1900 from step 1910. However, if the SW test results negative at 1906, then at 1916, the method 1900 may include initiating a normal operating mode. Further, at 1918, the method 1900 may include detecting if the LED is off or on. If the LED is not off, at 1920, the method 1900 may include initiating photo cell detection, and determining day or night. If day is detected, the method 1900 may repeat from step 1920. If night is detected, the method 1900 may proceed to step 1924. Further, if the LED is on at 1918, then the method 1900 may proceed to step 1922.

Further, at 1926, the method 1900 may include detecting if the LED is off or on within 3 seconds. A first time, the detecting may include engaging a manual accent override light override mode at 1928. Further, at 1930, the method 1900 may include switching on the light at a selected color temperature out of 2200 k/3000 k/4000 k/5000 k. A second time, the detecting may include engaging a manual security light override mode at 1932. Further, at 1934, the method 1900 may include switching on the light at a selected color temperature out of 5000K, or 2200/2800LM. Further, at 1936, the method 1900 may include detecting if the LED is off or on within 3 seconds. If the LED is on within 3 seconds, then at 1938, the LED may be turned off. Further, at 1940, the normal operation mode may be turned on. If the LED is not off within 3 seconds, at 1942, the method 1900 may include initiating photo cell detection, and determining day or night. If night is detected, the method 1900 may be repeated from step 1936. If day is detected, then at 1946, it may be determined to have been detected for more than 30 minutes. If day is not determined to have been detected for more than 30 minutes, the method 1900 may repeat from step 1936. If day is determined to have been detected for more than 30 minutes, then at 1948, the LED may be turned off. Further, at 1950, the normal operation mode may be engaged.

Further, after 1924, at 1952, the method 1900 may include engaging an off mode. Further, at 1954, the method 1900 may include initiating photo cell detection, and determining day or night. If day is detected, then at 1956, it may be determined to have been detected for more than 30 minutes. If day is not determined to have been detected for more than 30 minutes, night may be determined. If day is determined to have been detected for more than 30 minutes, at 1958, the normal operation mode may be engaged. Further, after night is detected, PIR may be detected at 1960. If PIR is not detected, the method 1900 may repeat from step 1954. If PIR is detected, then at 1962, the light may be switched on at color temperature selected from 5000K, 2200LM/2800LM for a time period selected from 1, 5, or 20 minutes. Further, at 1964, the light may be detected to be on for more than 1, 5, or 20 minutes. If light is detected to be on for more than 1, 5, or 20 minutes, then at 1968, LED mode may be engaged. Further, at 1970, off mode may be engaged at 1970. Further, if light is not detected to be on for more than 1, 5, or and 20 minutes, then at 1972, PIR may be detected. If PIR is detected, the method 1900 may repeat from step 1964. Further, if PIR is not detected, the method 1900 may repeat from 1962.

Further, after 1924, at 1974, the method 1900 may include engaging a 3-hour mode. Further, at 1976, the method 1900 may include turning light on at a color temperature selected from 2200K/3000K/4000K/5000K, and 1000LM. Further, at 1978, the method 1900 may include determining if the LED is on for more than 3 hours. If the LED is not on for more than 3 hours, then at 1980, the method 1900 may include initiating photo cell detection, and determining day or night. If night is detected, the method 1900 may repeat from step 1978. If day is detected, at 1982, day me be determined to have been detected for more than 30 minutes. If day is not determined to have been detected for more than 30 minutes, the method 1900 may repeat from step 1978. If day is determined to have been detected for more than 30 minutes, then at 1984, the method 1900 may include turning off the LED. Further, at 1986, the normal operation mode may be engaged. If the LED is on for more than 3 hours, at 1988, the LED may be turned off. Further, at 1990, the off mode may be turned on.

Further, after 1924, at 1994, the method 1900 may include engaging a 6-hour mode. Further, at 1996, the method 1900 may include turning light on at color temperature selected from 2200K/3000K/4000K/5000K, 1000LM. Further, at 1998, the method 1900 may include determining if the LED is on for more than 6 hours. If the LED is not on for more than 6 hours, then at 2000, the method 1900 may include initiating photo cell detection, and determining day or night. If night is detected, the method 1900 may repeat from step 1998. If day is detected, then at 2002, day me be determined to have been detected for more than 30 minutes. If day is not determined to have been detected for more than 30 minutes, the method 1900 may repeat from step 1998. If day is determined to have been detected for more than 30 minutes, at 2004, the LED may be turned off. Further, at 2006, the normal operation mode may be engaged. If the LED is on for more than 6 hours, at 2008, the LED may be turned off. Further, at 2010, the normal operation mode may be turned on.

Further, after 1924, at 2012, the method 1900 may include engaging the D2D mode. Further, at 2014, the method 1900 may include turning light on continuously at a selected color temperature from 2200K/3000K/4000K/5000K, 1000LM. Further, at 2016, the method 1900 may include initiating photo cell detection, and determining day or night. If night is detected, the method 1900 may repeat from step 2016. If day is detected, at 2018, day may be determined to have been detected for more than 30 minutes. If day is not determined to have been detected for more than 30 minutes, the method 1900 may repeat from step 2016. If day is determined to have been detected for more than 30 minutes, at 2020, the LED may be turned off. Further, at 2022, the normal operation mode may be engaged.

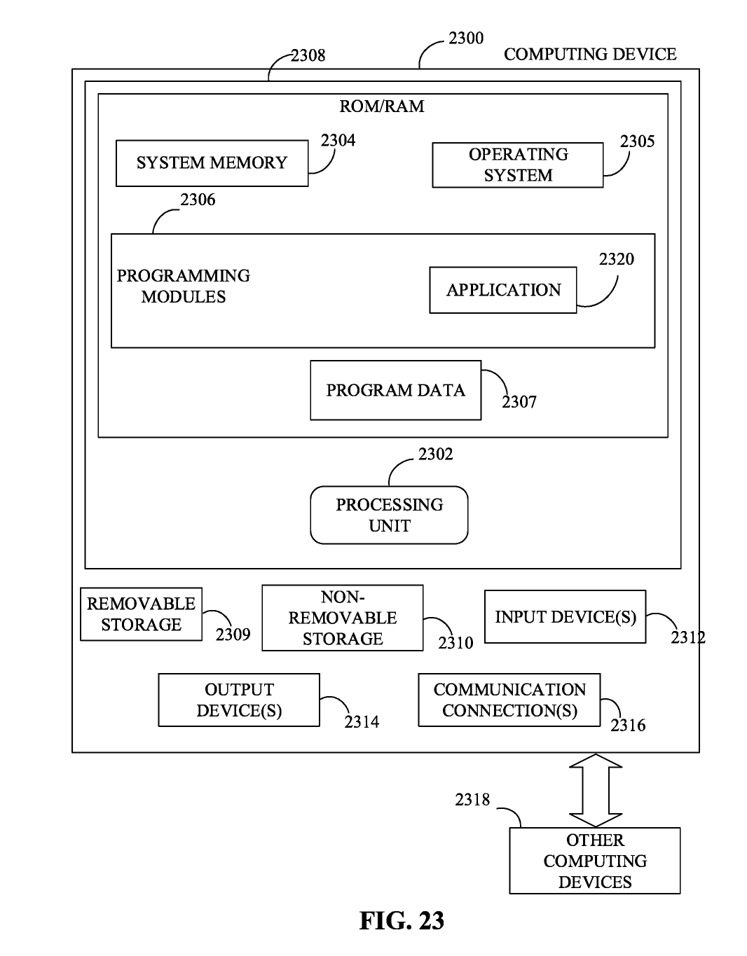

FIG. 23 is a block diagram of a system including computing device 2300. Consistent with an embodiment of the disclosure, the aforementioned memory storage and processing unit may be implemented in a computing device, such as computing device 2300 of FIG. 23. Any suitable combination of hardware, software, or firmware may be used to implement the memory storage and processing unit. For example, the memory storage and processing unit may be implemented with computing device 2300 or any of other computing devices 2318, in combination with computing device 2300. The aforementioned system, device, and processors are examples and other systems, devices, and processors may comprise the aforementioned memory storage and processing unit, consistent with embodiments of the disclosure.

With reference to FIG. 23, a system consistent with an embodiment of the disclosure may include a computing device or cloud service, such as computing device 2300. In a basic configuration, computing device 2300 may include at least one processing unit 2302 and a system memory 2304. Depending on the configuration and type of computing device, system memory 2304 may comprise, but is not limited to, volatile (e.g. random access memory (RAM)), non-volatile (e.g. read-only memory (ROM)), flash memory, or any combination. System memory 2304 may include operating system 2305, one or more programming modules 2306, and may include a program data 2307. Operating system 2305, for example, may be suitable for controlling computing device 2300's operation. Accordingly, in some embodiments, the programming modules 2306 may be implemented using one or more of software and hardware. For example, in an instance, the programming modules 2306 may be implemented as modules of a Digital Signal Processor (DSP). Further, in another instance, multiple types of completely DSP chip powered and/or analog physical hardware unit designs may be used. Further, the implementation of the programming modules could also be a combination of mostly DSP modules with some analog modules/processing as well. Further, in some embodiments, as long as the dithering module is implemented via a DSP chip, technically the rest of the modules may be analog modules. Accordingly, stress testing may be performed to determine which components would be best for each unit's physical size limitations.

Furthermore, embodiments of the disclosure may be practiced in conjunction with a graphics library, other operating systems, or any other application program and is not limited to any particular application or system. This basic configuration is illustrated in FIG. 23 by those components within a dashed line 2308.

Computing device 2300 may have additional features or functionality. For example, computing device 2300 may also include additional data storage devices (removable and/or non-removable) such as, for example, magnetic disks, optical disks, or tape. Such additional storage is illustrated in FIG. 23 by a removable storage 2309 and a non-removable storage 2310. Computer storage media may include volatile and nonvolatile, removable and non-removable media implemented in any method or technology for storage of information, such as computer-readable instructions, data structures, program modules, or other data. System memory 2304, removable storage 2309, and non-removable storage 2310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2300. Any such computer storage media may be part of device 2300. Computing device 2300 may also have input device(s) 2312 such as a keyboard, a mouse, a pen, a sound input device, a touch input device, etc. Output device(s) 2314 such as a display, speakers, a printer, etc. may also be included. The aforementioned devices are examples and others may be used.

Computing device 2300 may also contain a communication connection 2316 that may allow device 2300 to communicate with other computing devices 2318, such as over a network in a distributed computing environment, for example, an intranet or the Internet. Communication connection 2316 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal.

By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2304, including operating system 2305. While executing on processing unit 2302, programming modules 2306 (e.g., application 2320) may perform processes including, for example, one or more stages of methods, algorithms, systems, applications, servers, databases as described above. The aforementioned process is an example, and processing unit 2302 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A lighting apparatus comprising:
a voltage regulator configured to provide supply of electricity to the lighting apparatus;
a plurality of illumination means electrically coupled to the voltage regulator, wherein the plurality of illumination means is configured to generate light emission;
one or more motion sensors configured for detecting a motion in a vicinity of the lighting apparatus;
an ancillary sensor configured to detect a characteristic of environmental light;
a plurality of switches configured to control operation of the plurality of illumination means; and
a processor electrically coupled to each of the plurality of illumination means, the one or more motion sensors, the ancillary sensor and the plurality of switches, wherein the processor is configured to control operation of the plurality of illumination means based on the motion, the characteristic of environmental light and a plurality of outputs of the plurality of switches, wherein the plurality of illumination means is configured to operate in at least one of an accent light mode and a security light mode, wherein an illumination means of the plurality of illumination means, operating in the accent light mode, is configured to generate light emission based on the characteristic of environmental light, wherein the plurality of illumination means, operating in the security light mode, is configured to generate light emission at maximum intensity based on the characteristic of environmental light and detection of motion by the one or more motion sensors.

2. The lighting apparatus of claim 1 further comprising:
a wall-eave mount configured to be affixed to a surface;
a plurality of light housings configured to house the plurality of illumination means; and
a pivot joint configured to couple the plurality of light housings to the wall-eave mount, wherein the pivot joint is configured to permit pivotal motion of the plurality of light housings in relation to the wall-eave mount.

3. The lighting apparatus of claim 2, wherein the plurality of light housings further comprises a lighting lens configured to diffuse light emission from an illumination means comprised in the plurality of light housings.

4. The lighting apparatus of claim 1, wherein the processor further comprises a timing means configured for generating a timing signal, wherein the accent light mode is associated with an accent light period and the security light mode is associated with a security light period, wherein the plurality of illumination means is configured to remain operational for the accent light period for an arbitrary period of time prior to a security light period, wherein the plurality of illumination means is configured to remain operational for the security light period subsequent to detection of the motion.

5. The lighting apparatus of claim 4, wherein the characteristic comprises an intensity, wherein the plurality of illumination means is configured to remain operational for at least one of the accent light period and the security light period based on the intensity being below a predetermined threshold corresponding to dusk.

6. The lighting apparatus of claim 4, wherein the plurality of switches comprises an accent timer switch configured to control the accent light period.

7. The lighting apparatus of claim 6, wherein the accent timer switch is further configured to provide an option of selecting a Dawn-to-Dusk (D2D) mode, wherein the plurality of light illumination means, in the D2D mode, is configured to remain operational regardless of the motion and the characteristic of the environmental light.

8. The lighting apparatus of claim 4, wherein the plurality of switches comprises a security timer switch configured to control the security light period.

9. The lighting apparatus of claim 8, wherein the security timer switch is further configured to provide an option to test operation of the plurality of illumination means based on detection of the motion, regardless of the characteristic of environmental light, wherein the plurality of illumination means is configured to generate light emission for a predetermined duration of time starting from a time corresponding to the detection of the motion.

10. The lighting apparatus of claim 1, wherein the plurality of switches comprises a color temperature switch configured to vary a correlated color temperature (CCT) of the plurality of illumination means.

11. The lighting apparatus of claim 10, wherein the plurality of illumination means is configured to permit a variation of light emission corresponding to at least one of warm white, soft white, bright white, and daylight based on an output of the color temperature switch.

12. The lighting apparatus of claim 1, wherein the plurality of switches comprises a sensitivity switch, wherein the one or more motion sensors are configured to operate with a level of sensitivity based on an output of the sensitivity switch.

13. The lighting apparatus of claim 1 further comprising a relay electrically coupled to the processor, wherein the relay is configured to perform communication with at least one of a personal computing device and a remote control, wherein the relay is further configured to control state of the plurality of switches based on the communication.

14. The lighting apparatus of claim 13, wherein the relay is configured to communicate over a wireless communication channel.

15. The lighting apparatus of claim 13, wherein at least one of the personal computing device and the remote control is configured to present a graphical user interface (GUI) comprising graphical control elements similar to an appearance of the plurality of switches.

16. The lighting apparatus of claim 1 further comprising a manual override switch electrically coupled to the processor, wherein an activation of the manual override switch causes the plurality of illumination means to operate regardless of the motion and the characteristic of the light.

17. A lighting apparatus comprising:
a wall-eave mount configured to be affixed to a surface;
a plurality of light housings;
a pivot joint configured to couple the plurality of light housings to the wall-eave mount, wherein the pivot joint is configured to permit pivotal motion of the plurality of light housings in relation to the wall-eave mount;
a voltage regulator configured to provide supply of electricity to the lighting apparatus;
a plurality of illumination means electrically coupled to the voltage regulator, wherein the plurality of illumination means is configured to generate light emission, wherein the plurality of light housings is configured to house the plurality of illumination means;
one or more motion sensors configured for detecting a motion in a vicinity of the lighting apparatus;
an ancillary sensor configured to detect a characteristic of environmental light;
a plurality of switches configured to control operation of the plurality of illumination means; and
a processor electrically coupled to each of the plurality of illumination means, the one or more motion sensors, the ancillary sensor and the plurality of switches, wherein the processor is configured to control operation of the plurality of illumination means based on the motion, the characteristic of environmental light and a plurality of outputs of the plurality of switches, wherein the plurality of illumination means is configured to operate in at least one of an accent light mode and a security light mode, wherein an illumination means of the plurality of illumination means, operating in the accent light mode, is configured to generate light emission based on the characteristic of environmental light, wherein the plurality of illumination means, operating in the security light mode, is configured to generate light emission at maximum intensity based on the characteristic of environmental light and detection of motion by the one or more motion sensors.

18. The lighting apparatus of claim 17, wherein the processor further comprises a timing means configured for generating a timing signal, wherein the accent light mode is associated with an accent light period and the security light mode is associated with a security light period, wherein the plurality of illumination means is configured to remain operational for the accent light period for an arbitrary period of time prior to a security light period, wherein the plurality of illumination means is configured to remain operational for the security light period subsequent to detection of the motion.

19. The lighting apparatus of claim 17, wherein the characteristic comprises an intensity, wherein the plurality of illumination means is configured to remain operational for at least one of the accent light period and the security light period based on the intensity being below a predetermined threshold corresponding to dusk.

20. A method of operating a lighting apparatus, the method comprising:
receiving, using an ancillary sensor, detection of a characteristic of environmental light;
receiving, using a motion sensor, detection of a motion in a vicinity of the lighting apparatus;
generating, using a plurality of illumination means, light emission;
controlling, using a processor, operation of the plurality of illumination means based on the motion, the characteristic of environmental light and a plurality of outputs of a plurality of switches, wherein the plurality of illumination means is configured to operate in at least one of an accent light mode and a security light mode, wherein an illumination means of the plurality of illumination means, operating in the accent light mode, is configured to generate light emission based on the characteristic of environmental light, wherein the plurality of illumination means, operating in the security light mode, is configured to generate light emission at maximum intensity based on the characteristic of environmental light and detection of motion by the motion sensor.
